(19) United States
(12) Patent Application Publication
(10) Pub. No.: US 2006/0278535 A1
(43) Pub. Date: Dec. 14, 2006

(54) APPARATUS AND METHODS FOR REMOVING TUNGSTEN-CONTAINING COATINGS FROM A METAL COMPONENT

(75) Inventor: David C. Fairbourn, Sandy, UT (US)

Correspondence Address: WOOD, HERRON & EVANS, LLP, 2700 CAREW TOWER, 441 VINE STREET, CINCINNATI, OH, 45202, US

(73) Assignee: AEROMET TECHNOLOGIES, INC., Sandy, UT (US)

(21) Appl. No.: 11/423,363

(22) Filed: Jun. 9, 2006

Related U.S. Application Data
(60) Provisional application No. 60/689,482, filed on Jun. 10, 2005.
(60) Provisional application No. 60/690,262, filed on Jun. 14, 2005.

(51) Int. Cl. B23H 3/02; C03C 15/00; C23F 1/00; B23H 9/00

(52) U.S. Cl. 205/645; 205/640; 205/641; 156/345.15; 216/84; 216/100

(57) ABSTRACT

Apparatus and methods for removing tungsten-containing coatings from metal components, such as metal components used in aircraft and other aerospace vehicles. The metal component is DC coupled with a counter electrode and immersed in an aqueous bath that includes an active oxygen source and a ligand in a composition effective to remove the tungsten-containing coating. The aqueous bath may be maintained at a pH greater than about 7.0 and less than or equal to about 8.0. A sensor may be provided to periodically monitor the oxidation reduction potential of the aqueous bath. Another sensor may be provided to periodically monitor the pH of the aqueous bath.

### CROSS-REFERENCE TO RELATED APPLICATIONS

This application claims the benefit of U.S. Provisional Application No. 60/689,482 filed Jun. 10, 2005 and U.S. Provisional Application No. 60/690,262 filed Jun. 14, 2005, the disclosure of each of which is hereby incorporated by reference herein in its entirety.

### FIELD OF THE INVENTION

The invention relates to stripping coatings from metal components and, more particularly, to apparatus and methods for removing tungsten-containing coatings from metal components used in aircraft and other aerospace vehicles.

### BACKGROUND OF THE INVENTION

Aircraft landing gears include metal components, such as inner and outer cylinders, axles, pins, and actuators, formed from high strength structural materials like steel alloys. The metal components of aircraft landing gears, as well as the metal segments or components of exhaust augmentor flaps or turkey feathers found in aircraft engines, are often encapsulated or at least partially covered by a coating to provide a beneficial effect, such as corrosion resistance. For example, a tungsten-containing coating, such as WCCo constituted by about 80 percent tungsten, may be applied to these metal components by, for example, a plasma spraying technique or by a high velocity oxygen fuel (HVOF) thermal spray process.

Landing gears and exhaust augmentor flaps are periodically removed from aircraft to inspect the material forming the metal components for stress corrosion, cracking, or other evidence of a condition that could lead to a field failure while in service. The inspection requires that the tungsten-containing coating be stripped so that the coating does not interfere with the inspection process. For example, a porous coating may restrict the ability of a penetrant to reach the underlying structural material. If the component passes inspection, a new tungsten-containing coating is applied to the metal component before the landing gear or exhaust augmentor flap is returned to service.

Conventional processes for stripping tungsten-containing coatings suffer from various deficiencies. A reverse plating process using an aqueous bath containing tartaric acid may be used to remove tungsten-containing coatings. However, this particular reverse plating process is expensive and slow. Aqueous baths containing acids may cause metal components formed from high strength steel alloys to be susceptible to hydrogen ion embrittlement. Embrittled metal components may become susceptible to damage from shock. Although residual trapped hydrogen in the stripped metal components may be removed by a low temperature bake, the required length of the bake slows process throughput.

Stripping solutions are known for removing compounds of titanium from base metals. Generally, these stripping methods immerse the component in a solution including a source of active oxygen and a suitable acid. For stripping solutions in which hydrogen peroxide acts as the active oxygen source in the composition, the solution pH must be kept below about 4.0 to avoid spontaneous loss of the active oxygen at a dramatic rate. To avoid this problem, hydrogen peroxide may be replaced with a different type of active oxygen source such as a chemical substance like sodium perborate tetrahydrate that dissociates in water to form active oxygen. The solution must also include an alkaline source of hydroxyl ions, such as ammonium hydroxide, sodium hydroxide, or potassium hydroxide, that maintains the solution pH at a pH value exceeding 8.0. The effectiveness of solutions with this composition to strip tungsten-containing coatings may be improved by introducing a counter electrode into the solution along with the metal component, as taught in my U.S. Pat. No. 6,294,072.

Nevertheless, there is a need for improved apparatus and methods to efficiently remove tungsten-containing coatings from metal components used in aircraft and other aerospace vehicles.

### SUMMARY OF INVENTION

The invention provides, in one aspect, an improved method for efficiently removing a tungsten-containing coating from a metal component used in aircraft and other aerospace vehicles that measures an oxidation reduction potential of an aqueous bath, in which the metal component is at least partially immersed, and adds an amount of the active oxygen source to the aqueous bath to increase the oxidation reduction potential if the measured oxidation reduction potential differs from a reference oxidation reduction potential. By virtue of the foregoing, there is provided a method for removing tungsten-containing coatings in which the active oxygen content of the aqueous bath is tracked and adjusted to optimize removal as the composition or chemistry of the aqueous bath is altered by the coating-removal process.

The invention provides, in another aspect, an improved method for efficiently removing a tungsten-containing coating from a metal component used in aircraft and other aerospace vehicles adjusting the composition of an aqueous bath, in which the metal component is at least partially immersed, to maintain the pH value greater than about 7.0 and less than or equal to about 8.0. By virtue of the foregoing, there is provided a method for removing tungsten-containing coatings in which the pH value of the aqueous bath is adjusted so that the substrate of the metal component is not damaged by chemical attack by the aqueous bath. The adjustments may be made in response to changes in the composition or chemistry of the aqueous bath resulting from the coating-removal process.

The invention provides, in yet another aspect, an improved apparatus that includes a first sensor in fluid communication with an aqueous bath, in which the metal component is at least partially immersed, and adapted to measure an oxidation reduction potential of the aqueous bath. The apparatus further includes a control system responsive to output signals indicative of the oxidation reduction potential supplied from the first sensor to cause an additional amount of a first aqueous bath component to be added to the aqueous bath. Advantageously, the sensor and control system cooperate to adjust the composition or chemistry of the aqueous bath if the measured value of the oxidation reduction potential deviates from a reference value, which maintains the efficiency of the stripping process as the coating-removal process modifies the composition or chemistry of the aqueous bath.

These and other objects and advantages of the invention shall be made apparent from the accompanying drawings and description thereof.

### BRIEF DESCRIPTION OF THE DRAWINGS

The accompanying drawings, which are incorporated in and constitute a part of this specification, illustrate an embodiment of the invention and, together with a general description of the invention given above, and the detailed description of the embodiment given below, serve to explain the principles of the invention.

FIG. 1 is a highly schematic, not to scale view of a metal component bearing a tungsten-containing coating to be stripped in accordance with the invention;

FIG. 2 is a cross-sectional view of an edge portion of the metal component and tungsten-containing coating of FIG. 1;

FIG. 3 is a diagrammatic view of an apparatus for stripping the coating from the metal component of FIG. 1 in accordance with an embodiment of the invention; and

FIG. 4 is a cross-sectional view similar to FIG. 2 after the coating is stripped from the metal component.

### DETAILED DESCRIPTION OF PREFERRED EMBODIMENTS

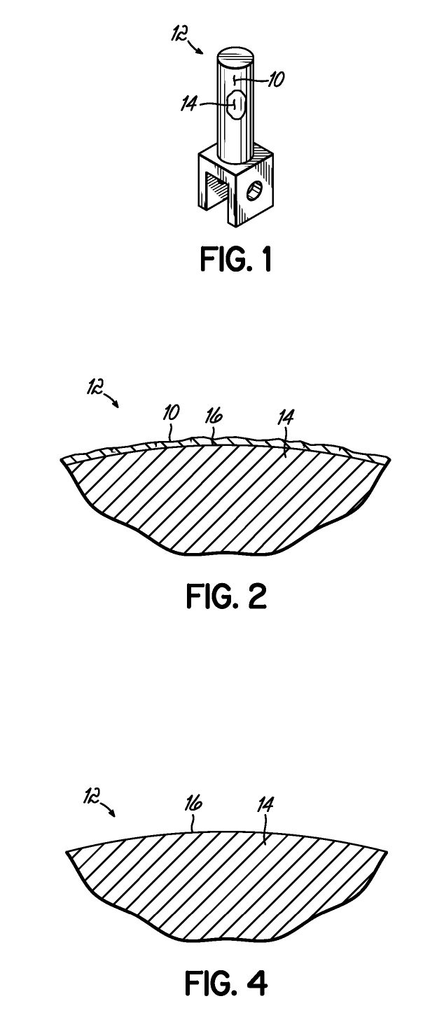

With reference to FIGS. 1-4, the invention provides for the removal or stripping of a tungsten-containing coating 10, such as a tungsten carbide cobalt (WCCo) coating or a tungsten carbide cobalt-chromium (WC—CoCr) coating, from a metal component 12 representative of a metal component of an aircraft landing gear. Generally, tungsten comprises the major element in the composition of coating 10. A substrate 14 of the metal component 12 is formed from a structural material, such as a high strength structural steel alloy, that differs in composition from the material forming the coating 10 and, preferably, is an alloy that contains either a low concentration of tungsten or no tungsten. After the coating 10 is removed, an original surface 16 of substrate 14 is revealed.

The landing gear is understood to include additional metal components, in addition to the illustrated metal component 12, that would benefit from coating stripping as described herein. The invention also contemplates that the metal component 12 may consist of an assembly of several individual components that are simultaneously removed by a single stripping operation. Exemplary metal components 12 of a landing gear include, but are not limited to, the inner and outer cylinders, axles, pins, actuators such as hydraulic actuators, and assemblies of these and other individual components. The assemblies may include additional components (not shown) that are uncoated by the coating 10.

Metal component 12 may also comprise an exhaust augmentor flap segment or component normally used in service near the exhaust outlet of a jet engine. The substrate 14 of this type of metal component 12 may be formed from a material, such as titanium, Inconel 718 (a nickel based superalloy), or another suitable material as understood by a person having ordinary skill in the art.

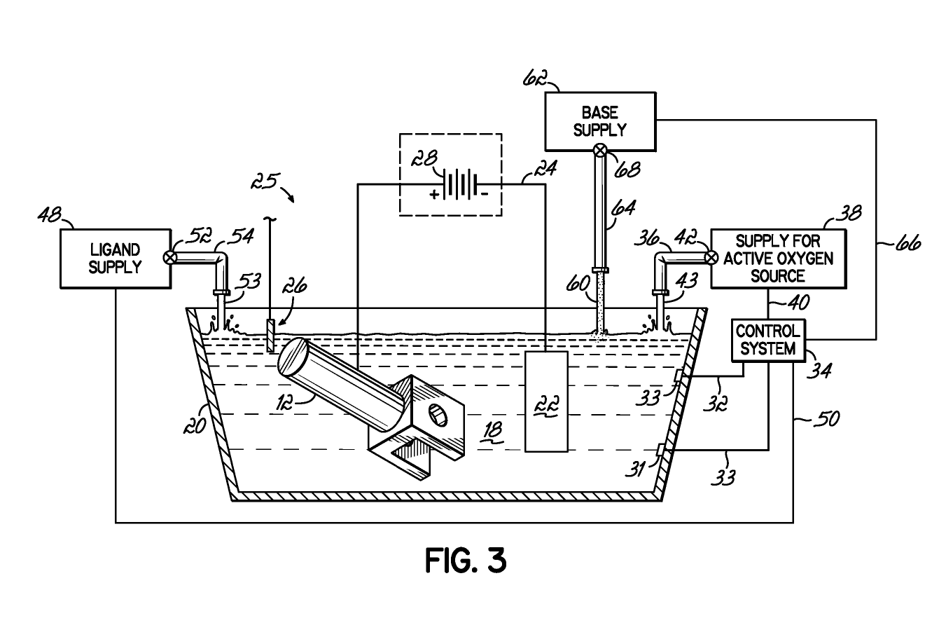

In accordance with the principles of the invention, the tungsten-containing coating 10 is stripped from at least a portion of the metal component 12 to reveal the original surface 16 of the substrate 14. Metal component 12 is associated with an aqueous bath 18, such as by being fully or at least partially immersed in a solution-filled tank or container 20 of a stripping apparatus 25 as shown in FIG. 3. Only a portion of the metal component 12 may be wetted by the aqueous bath 18 so that the coating 10 is only removed from the wetted portion and remains substantially intact on the unwetted regions after the stripping process. It is contemplated that residual coating 10 may remain on a portion of the metal component 12. The invention contemplates that the stripping process removing the coating 10 may also remove or mill away a minor thickness of the substrate 14 of the metal component 12 after the coating 10 is at least partially removed. Preferably, the substrate 14 is undamaged by the stripping operation.

Container 20 may be made of any material appropriate for the particular application, such selection being within the ordinary skill of one in the art, and for example, may comprise plastic or metal, such as stainless steel. The container 20 is dimensioned and the volume of solution constituting aqueous bath 18 is sufficient to receive and fully immerse the metal component 12. The metal component 12, which is part of an assembly designed to support the massive weight of an aircraft under the violent impact and shock of landing, is understood by persons of ordinary skill in the art to be dimensionally large and bulky. Consequently, removing coating 10 from component 12 requires a relatively large container 20 and a relatively large volume of solution in aqueous bath 18. Consequently, container 20 is of a type that would not be used in small scale laboratory experiments.

For example, container 20 may be sized to hold a bath 18 of up to 9000 gallons of solution for stripping metal components 12 that may approach about 15 feet in length and about 1 foot in diameter. Alternatively, if the metal component 12 originates from an exhaust augmentor flap, container 20 may be sized to hold a bath 18 of up to 40 liters of solution for stripping metal components 12 of an exhaust augmentor flap that may approach about 19 inches in length and about 8 inches or so in width.

The aqueous bath 18 may be at room temperature, which varies according to the environment, but it is typically between 55° F. and 105° F. (13° C. to 41° C.). Advantageously, the aqueous bath 18 may be maintained at about 90° F. (32° C.). However, the aqueous bath 18 may be warmed to higher temperatures, if desired, to accelerate the stripping process. This may be achieved by adding a heat source (not shown) adapted to heat the electrolyte in aqueous bath 18.

With reference to FIG. 3, the stripping apparatus 25 further includes a counter electrode 22 associated with aqueous bath 18, such as by being immersed in container 20 with metal component 12. The counter electrode 22 may be formed from graphite or from other materials such as gold, platinum, or Hastelloy C-276. Metal component 12 has a first natural standard electrode potential E°, and counter electrode 22 has a second natural standard electrode potential E° greater than the E° of the metal component 12. Counter electrode 22 and metal component 12 are DC coupled by an electrical path or coupling, as exemplified by a wire 24, to establish a circuit. The surface area of the counter electrode 22 may be approximately equal to the surface area of the metal component 12. Alternatively, the counter electrode 22 may be introduced as a liner inside the container 20, and the metal component 12 may be placed or otherwise rest directly on the liner to establish the DC coupling with the counter electrode 22.

The standard electrode potential, E°, which is expressed in volts, is defined as the potential of an element immersed in a solution of its ions at unit activity. E° may be measured by electrochemical impedance spectroscopy (EIS). A driving or electromotive force (EMF) results from the relative potential forces of the two dissimilar electrodes (i.e., the metal component 12 and the counter electrode 22). The greater the magnitude of the differential between the E° values of the metal component 12 and the counter electrode 22, the greater the EMF produced, and thus a faster and more effective stripping of the tungsten-containing coating 10 may be obtained.

Although not wishing to be bound by theory, the use of the counter electrode 22 is believed to eliminate or significantly reduce the risks associated with hydrogen embrittlement of the metal component 12 by reducing hydrogen infiltration from the aqueous bath 18 into the metal component 12. The metal component 12 operates as an anode during stripping, while the counter electrode 22 operates as the cathode on which substantially all cathodic activity occurs. The surface 16 of metal component 12 surrenders electrons by virtue of the E° differential between the metal component 12 and the counter electrode 22.

The stripping process is continued until the tungsten-containing coating 10 is at least partially removed and, preferably, completely removed from metal component 12 to expose original surface 16, as is apparent in FIG. 4. The solution in bath 18 may be stirred or otherwise agitated to enhance the removal rate of coating 10. For example, an ultrasonic probe 26 may be inserted into the aqueous bath 18 to produce shock waves that agitate the solution constituting the aqueous bath 18. Other examples of agitating mechanisms are a mechanical agitator with, for example, a bladed impeller or a pump (not shown) that adds and extracts solution from the tank to thereby agitate the aqueous bath 18. The pumped solution may be filtered to remove particulates that accumulate in the aqueous bath 18. The pumping may be continuous or intermittent and the filtered solution may be returned to the container 20 through a sparger that injects the returned solution with jets oriented to direct flows generally toward the metal component 12.

With continued reference to FIG. 3, an optional external power source 28 may be placed in the circuit coupling the metal component 12 and counter electrode 22 to add an additional EMF that may, for example, be in the range of one (1) to six (6) volts. The additional EMF modifies the E° differential between the metal component 12 and the counter electrode 22. A positive cathode of the optional power source 28 is DC coupled to the metal component 12, and a negative anode of the optional power source 28 is DC coupled to the counter electrode 22. The power source 28 supplies an external voltage in the negative sense from the counter electrode 22 to the metal component 12 that expands the effect of the natural E° differential. The presence of the negative potential is believed to advantageously increase the removal rate of the coating 10 while the metal component 12 is immersed in the aqueous bath 18 and DC coupled with the counter electrode 22. In particular, the use of power source 28 may be particularly beneficial for increasing the removal rate of WCCoCr, wherein the chromium is only 4% of the chemistry of the coating 10.

In one aspect of the invention, the electrolyte in aqueous bath 18 may be a dilute aqueous solution consisting of a mixture of water (H₂O), an active source of oxygen such as hydrogen peroxide (H₂O₂), and a substance that behaves as a ligand for tungsten metal. The ligand may be an acid selected from citric acid (C₆H₈O₇), oxalic acid (C₂H₂O₄), tartaric acid (C₄H₆O₆), glucose (6-(hydroxymethyl)oxane-2,3,4,5-tetrol), or formic acid (CH₂O₂). A person having ordinary skill in the art understands that a ligand is an atom, ion, or molecule that donates one or more of its electrons through a coordinate covalent bond to, or shares its electrons through a covalent bond with one or more central metal atoms or ions to form a complex.

The oxidization reduction potential of the aqueous bath 18 provides a qualitative measure of the oxidation power of the aqueous bath 18. The oxidation power provides an indication of the solution's ability to oxidize another the constituent material of the tungsten-containing coating 10. The oxidization reduction potential is related to the concentration of active oxygen in the aqueous bath 18 and the activity or strength of the source of active oxygen. As the tungsten-containing coating 10 is removed, the active oxygen is consumed in the process, which causes the oxidation reduction potential of the aqueous bath 18 to change in a measurable manner. The pH of the aqueous bath 18 also changes during the coating removal process.

In one specific embodiment of the invention, the aqueous bath 18 includes a volume of hydrogen peroxide sufficient to provide a level of about 3 percent of the total solution volume, about 2 grams of citric acid per liter of solution, and the rest water. Although not wanting to be bound by theory, the use of citric acid or another of the described acids or functionally-equivalent acids is believed to enhance the removal of tungsten from the coating 10 by operating as a chelating agent that binds the tungsten ions removed from metal component 12 by the hydrogen peroxide and, on that basis, to enhance the removal rate for stripping coating 10 from metal component 12.

The stripping apparatus 25 may include a probe or sensor 30 capable of measuring the oxidation reduction potential of the aqueous bath 18 during the stripping process. Sensor 30 may be any suitable oxidation reduction potential sensor such as, for example, an oxygen sensor or an electrochemical-type sensor. In particular, sensor 30 may comprise an electrode with a measuring half cell comprised of platinum metal immersed in the aqueous bath 18 and sealed a reference half cell to which the platinum half cell is referenced. Although oxidation reduction potential sensor 30 is depicted as positioned inside the container 20 and wetted by bath 18, sensor 30 may alternatively be a non-contact sensor otherwise positioned. Oxidation reduction potential sensor 30 generates output signals that correspond to, or are proportional to, successive measurements of the oxidation reduction potential of aqueous bath 18.

The stripping apparatus 25 may include a probe or sensor 31 capable of measuring the pH of the aqueous bath 18 during the stripping process. The pH sensor 31 may be any suitable pH sensor, such as a device having a working electrode and a reference electrode. Although pH sensor 31 is depicted as positioned inside the container 20 and wetted by bath 18, pH sensor 31 may alternatively be a non-contact sensor otherwise positioned. Sensor 31 generates output signals that correspond to, or are proportional to, successive measurements of the pH of aqueous bath 18. As understood by a person of ordinary skill in the art, the pH is a measure of the activity of hydrogen ions (H⁺) in the aqueous bath 18 and, therefore, the acidity or alkalinity. The pH value, which is a dimensionless number between 0.0 and 14.0, indicates whether a solution is acidic (pH<7), neutral (pH=7), or basic/alkaline (pH>7).

With continued reference to FIG. 3, the oxidation reduction potential sensor 30 and pH sensor 31 are coupled electrically with a control system 34 of the stripping apparatus 25 by communication links 32, 33, respectively. The communication links 32, 33 may be constituted by a cable or wire, a radiofrequency (RF) link, or an infrared (IR) link. The output signals generated by the oxidation reduction potential sensor 30 are directed over the communication link 32 to the control system 34. Similarly, the output signals generated by the pH sensor 31 are directed over the communication link 33 to the control system 34. The output signals from sensors 30, 31 may be provided to the control system 34 at various different time intervals between successive measurements as required to maintain control over the composition of the solution forming the aqueous bath 18. The output signals may be periodically, aperiodically, or continuously generated in response to the successive measurements, but are repeatedly measured without user intervention and supplied as feedback to the control system 34 for responding to the generated output signals.

Control system 34 is electrically coupled with an active oxygen source supply 38 of the stripping apparatus 25 over a communications link 40, such a wire, a radiofrequency (RF) link, or an infrared (IR) link. The active oxygen source supply 38 includes a valve or flow control device 42 that the control system 34 can command to open and close for adding additional amounts 43 of the active oxygen source to the aqueous bath 18. The active oxygen source supply 38 is a conventional structure that includes a bulk supply of the active oxygen source and any additional components as understood by a person of ordinary skill in the art required for holding and transferring such substances.

Control system 34 is also electrically coupled with a ligand supply 48 of the stripping apparatus 25 over a communications link 50, such a wire, a radiofrequency (RF) link, or an infrared (1R) link. The ligand supply 48 includes a valve or flow control device 52 that the control system 34 can command to open and close for adding additional amounts 53 of the ligand to the aqueous bath 18. The ligand supply 48 is a conventional structure that includes a bulk supply of the ligand and any additional components as understood by a person of ordinary skill in the art required for holding and transferring such substances.

Control system 34 relies on a software algorithm and/or user input to respond to electrical signals supplied from sensor 30. Specifically, control system 34 may respond to a change (e.g., deficiency) in the amount of the source of active oxygen, as indicated by successive output signals representative of the measured oxidation reduction potential supplied from sensor 30, by causing additional amounts 43 of the active oxygen source to be transferred from the active oxygen source supply 38 through a transfer pathway 36 to the aqueous bath 18. A person of ordinary skill in the art will appreciate that other types of fluid transfer pathways 36 may be established, such as piping (not shown) extending from the active oxygen source supply 38 through the wall of the container 20. In the illustrated embodiment, the transfer pathway 36 is illustrated as introducing added amounts 43 of the active oxygen source at a location proximate to the sensor 30. However, the invention is not so limited as the transfer pathway 36 may introduce these additional amounts 43 of the active oxygen source at other locations so long as the added amounts are contained inside of container 20.

The control system 34 of the stripping apparatus 25 may compare the measured oxidation reduction potential as indicated by the sensor 30 with a reference oxidation reduction potential. If the measured oxidation reduction potential differs from the reference oxidation reduction potential, the control system 34 may instruct the active oxygen source supply 38 to add an amount 43 of the source of active oxygen to the aqueous bath 18 effective to increase the oxidation reduction potential. The oxidation reduction potential of the aqueous bath 18 may be increased to a measured value comparable or equal to the reference value. The control system 34 may regulate the rate of addition of the active oxygen source to maintain the measured oxidation reduction potential within an effective range for at least partially removing the tungsten-containing coating 10 from the immersed portion of the metal component 12.

Control system 34 likewise relies on a software algorithm and/or user input to respond to electrical signals supplied from sensor 31. Specifically, control system 34 may respond to a change in the pH of aqueous bath 18, as indicated by successive output signals representative of the measured pH supplied from sensor 31, by causing additional amounts 53 of the ligand to be transferred from the ligand supply 38 through a transfer pathway 54 to the aqueous bath 18. A person of ordinary skill in the art will appreciate that other types of fluid transfer pathways 54 may be established, such as piping (not shown) extending from the ligand supply 48 through the wall of the container 20. In the illustrated embodiment, the transfer pathway 54 is illustrated as introducing added amounts 53 of the ligand at a location remote from the sensor 31. However, the invention is not so limited as the transfer pathway 54 may introduce these additional amounts 53 of the ligand at other locations so long as the added amounts are contained inside of container 20.

The control system 34 of the stripping apparatus 25 may compare the measured pH as indicated by the sensor 31 with a reference pH. If the measured pH differs from the reference pH, the control system 34 may instruct the ligand supply 38 to add an amount of the ligand to the aqueous bath 18 effective to decrease (or increase) the pH. The pH of the aqueous bath 18 may be increased to a measured pH value comparable or equal to the reference pH value. The control system 34 may regulate the rate of addition of the ligand to maintain the measured pH value within an effective range for at least partially removing the tungsten-containing coating 10 from the immersed portion of the metal component 12 without attacking or damaging the substrate 14.

The invention contemplates that the active oxygen source and/or ligand may be added to the aqueous bath 18 as a solid, rather than in a liquid form as depicted in FIG. 3.

With reference to FIG. 4, the stripping apparatus 25 may include a base supply 62 that is adapted to transfer amounts 60 of a base substance through a transfer pathway 64 to the aqueous bath 18. A person of ordinary skill in the art will appreciate that other types of fluid transfer pathways 64 may be established, such as piping (not shown) extending from the base supply 48 through the wall of the container 20. Control system 34 is electrically coupled with the base supply 62 of the stripping apparatus 25 over a communications link 66, such a cable or wire, a radiofrequency (RF) link, or an infrared (IR) link. The base supply 62 includes a valve or flow control device 68 that the control system 34 can command to open and close for adding additional amounts 60 of the base to the aqueous bath 18. Base supply 62 is a conventional structure that includes a bulk supply of the base and any additional components as understood by a person of ordinary skill in the art required for holding and transferring such substances. The base supply 62 may be omitted if the composition of the aqueous bath 18 lacks a base/alkaline substance.

The control system 34 of the stripping apparatus 25 may compare the measured pH as indicated by the sensor 31 with a reference pH. If the measured pH differs from the reference pH, the control system 34 may instruct the base supply 62 to add an amount of the base to the aqueous bath 18 effective to decrease the pH. The pH of the aqueous bath 18 may be decreased to a measured pH value comparable or equal to the reference pH value by instructing the base supply 62 to add amounts 60 of the base to the aqueous bath 18. The control system 34 may regulate the rate of addition of the base to maintain the measured pH value within an effective range for at least partially removing the tungsten-containing coating 10 from the immersed portion of the metal component 12 without attacking or damaging the substrate 14.

The original surface 16, when exposed after the coating 10 is stripped, may be susceptible to damage from, for example, corrosion. To that end, amounts of the base substance are added to the aqueous bath 18 sufficient to adjust the pH to a pH value that prevents damage to the metal component 12 after the coating 10 is removed. Damage is prevented without significantly altering the stripping rate or, at the least, only altering the stripping rate within tolerable limits. The added amount 60 of the base is be sufficient to adjust the pH to a pH value greater than about 7.0 but less than, or equal to, 8.0. This maintains the solution pH at a neutral to slightly basic/alkaline value.

An exemplary chemical substance useful for adjusting the pH is sodium hydroxide (NaOH), which is available commercially in various solid forms, e.g., pellets, sticks, or chips, and in water solutions of various concentrations, and is commonly known as caustic soda, lye, or sodium hydrate. The ability to adjust the pH may be particularly advantageous for preventing corrosion, which may have the form of rust, of metal components 12 in which the substrate 14 is formed from a material susceptible to corrosion. Exemplary corrosion-susceptible materials for substrate 14 include, but are not limited to, 4140 and 4340 stainless steels.

For operation at these pH values, the source of active oxygen in the aqueous bath 18 is a chemical compound or substance such as sodium perborate tetrahydrate (NaBO₃.4H₂O), sodium perborate monohydrate (NaBO₃.H₂O) prepared by dehydrating sodium perborate tetrahydrate, sodium percarbonate (Na₂CO₃.1½H₂O₂), boric acid (H₃BO₃), mixtures of these chemical compounds or substances, or the like, at a level of from 1% to 30% by weight of the composition. The chemical substance supplying the active oxygen may undergo dissociation or hydrolysis in contact with water, producing active oxygen in the aqueous bath 18. The pH of the aqueous bath 18 may be adjusted using the alternative active oxygen source to a pH value greater than about 7.0 and less than, or equal to, 8.0 without concerns regarding the evaporative loss of hydrogen peroxide. Replacing hydrogen peroxide with a different active oxygen source eliminates the difficulties associated with the expected loss of hydrogen peroxide from the aqueous bath 18 at elevated pH values.

The control system 34 may respond to a change in the pH of aqueous bath 18 occurring during the coating removal process, as indicated by successive output signals representative of the measured pH supplied from sensor 31, by causing amounts 60 of the base substance to be transferred to the aqueous bath 18. This increases the pH to maintain the pH within the desired range.

Regions on the metal component 12 may be masked with a protective coating to prevent contact with, or wetting by, the aqueous bath 18. In particular, regions on metal component 12 that are not coated by tungsten-containing coating 10 may be covered by the protective coating, which operates as a barrier preventing contact or wetting by the aqueous bath 18. After the stripping process removes coating 10, the protective coating is likewise stripped. Certain types of metal components 12 may include an outer paint layer that is removed before the protective coating is applied or the metal component 12 is at least partially immersed in the aqueous bath 18 to strip tungsten-containing coating 10. An exemplary protective coating is a silane, such as BTSE.

U.S. Pat. Nos. 6,294,072, 6,645,365, and 6,837,985, which describe similar apparatus and methods for stripping, are hereby incorporated by reference herein in their entirety.

While the invention has been illustrated by the description of an embodiment thereof and specific examples, and while the embodiment has been described in considerable detail, it is not intended to restrict or in any way limit the scope of the appended claims to such detail. Additional advantages and modifications will readily appear to those skilled in the art. For example, a person of ordinary skill in the art will appreciate that general coatings may be stripped from other types of metal components using a stripping apparatus including the concentration sensor, as described herein, and that this aspect of the invention is not limited to stripping tungsten-containing coatings from metal components of landing gears and exhaust augmentor flaps. The invention in its broader aspects is therefore not limited to the specific details, representative apparatus and methods and illustrative examples shown and described. Accordingly, departures may be made from such details without departing from the scope or spirit of applicant's general inventive concept.

What is claimed is:

1. A method for at least partially removing a tungsten-containing coating from a metal component, the method comprising:
immersing at least a portion of the metal component in an aqueous bath comprising water, an active oxygen source, and a ligand;
at least partially removing the tungsten-containing coating from the immersed portion of the metal component while the metal component portion is immersed in the aqueous bath;
measuring an oxidation reduction potential of the aqueous bath;
comparing the measured oxidation reduction potential with a reference oxidation reduction potential; and
adding an amount of the active oxygen source to the aqueous bath to increase the oxidation reduction potential if the measured oxidation reduction potential differs from the reference oxidation reduction potential.

2. The method of claim 1 further comprising:
regulating the rate of addition of the active oxygen source to maintain the measured oxidation reduction potential within an effective range for at least partially removing the tungsten-containing coating from the immersed portion of the metal component.

3. The method of claim 1 further comprising:
DC coupling the metal component with a counter electrode having a greater E° than the metal component while at least partially removing the tungsten-containing coating from the immersed portion of the metal component.

4. The method of claim 3 wherein DC coupling the metal component with the counter electrode further comprises:
placing an external power source in a circuit coupling the metal component and the counter electrode.

5. The method of claim 1 further comprising:
partially masking the metal component before immersion in the aqueous bath.

6. The method of claim 1 further comprising:
measuring a pH value of the aqueous bath; and
adjusting a pH of the aqueous bath to maintain the measured pH value less than about 4.0.

7. The method of claim 6 wherein adjusting the pH of the aqueous bath further comprises:
adding an amount of the ligand to the aqueous bath effective to decrease the pH to a pH value less than about 4.0.

8. A method for removing at least a portion of a tungsten-containing coating from a metal component, the method comprising:
immersing at least a portion of the metal component in an aqueous bath comprising water, an active oxygen source, and a ligand;
measuring a pH value of the aqueous bath while the metal component portion is immersed in the aqueous bath; and
adjusting the composition of the aqueous bath in response to the measured pH value to maintain the pH value within a range greater than about 7.0 and less than or equal to about 8.0.

9. The method of claim 8 wherein adjusting the composition of the aqueous bath:
adding amounts of a base sufficient to maintain the measured pH value within the range.

10. The method of claim 9 further comprising:
controlling the added base amounts with a control system electrically coupled with a sensor measuring the pH value and electrically coupled with a supply for adding the amounts of the base in response to the measured pH value.

11. The method of claim 9 further comprising:
regulating the rate at which the base is added to the aqueous bath to maintain the measured pH value within the range.

12. The method of claim 9 further comprising:
DC coupling the metal component with a counter electrode having a greater E° than the metal component that is in fluid communication with the aqueous bath; at least partially removing the tungsten-containing coating from the immersed metal component portion;

13. The method of claim 12 wherein DC coupling the metal component with the counter electrode further comprises:
placing an external power source in a circuit coupling the metal component and the counter electrode.

14. The method of claim 8 further comprising:
partially masking the metal component before immersion in the aqueous bath.

15. The method of claim 8 wherein preparing the aqueous bath further comprises:
introducing a substance into the aqueous bath that dissociates, when contacted by water, to produce the active oxygen.

16. An apparatus for removing at least a portion of a tungsten-containing coating from a metal component using an aqueous bath with a composition having multiple components and held in a container dimensioned to at least partially receive the metal component, the apparatus comprising:
a first sensor in fluid communication with the aqueous bath, the first sensor adapted to measure an oxidation reduction potential of the aqueous bath and generate output signals corresponding to the measured oxidation reduction potential; and
a control system electrically coupled with the sensor, the control system responsive to the output signals from the first sensor to cause an additional amount of a first aqueous bath component to be added to the aqueous bath.

17. The apparatus of claim 16 further comprising:
a counter electrode disposed in the container, the counter electrode adapted to be DC coupled with the metal component, and the counter electrode having a greater E° than the metal component;

18. The apparatus of claim 17 further comprising:
an external power source in a circuit DC coupling the metal component and the counter electrode.

19. The apparatus of claim 16 further comprising:
a second sensor adapted to measure the pH of the aqueous bath and generate output signals corresponding to the measured pH, the control system electrically coupled with the second sensor, and the control system responsive to the output signals from the second sensor to cause an additional amount of a second aqueous bath component to be added to the aqueous bath.
